(19) United States
(12) Patent Application Publication
(10) Pub. No.: US 2011/0216998 A1
(43) Pub. Date: Sep. 8, 2011

(54) OPTICAL SUB-ASSEMBLY

(76) Inventors: Keith J. Symington, Livingston (GB); John Michael Goward, Regensburg (DE)

(21) Appl. No.: 13/055,226

(22) PCT Filed: Jul. 22, 2009
(86) PCT No.: PCT/GB2009/050906

§ 371 Date: May 17, 2011

(30) Foreign Application Priority Data
Jul. 22, 2008 (GB) 0813396.9

(51) Int. Cl. G02B 6/122; G02B 7/02; G02B 27/10; B32B 37/00; B32B 38/04; B23P 11/00

(52) U.S. Cl. 385/14; 359/819; 359/619; 156/60; 156/250; 29/428; 216/24

(57) ABSTRACT

Described is a new wafer scale optical sub-assembly (OSA) and a method of production of such an OSA. Also described are optical wafers which form the central building block for the OSAs. The optical wafers comprise embedded optical features, which are positioned with reference to a single reference fiducial so as to avoid stacking of alignment errors. The embedded optical features may include refractive and/or waveguide optical channels. Cross-talk reduction features may also be provided between the embedded optical features. Embedding the optical features within the optical wafers protects the optical features from damage or contamination. The design of the optical features allows both transmit and receive functionality and arrays of optical devices to be packaged together.

The present invention relates to the field of optical sub-assemblies (OSA) and in particular to a new wafer scale OSA and method of production thereof.

The packaging methods currently used for optical transceivers, regardless of whether the end application is datacom or telecom, are dominated by the TO-can and transceiver design combination. TO-can packaging of an opto-electrical conversion device generally includes a metallic case with a transmission window or opening on top for transmitting or receiving optical signals. As such, the TO-can is the first line of packaging used to embed an optoelectronic die followed by the transceiver PCB which is used to carry higher power signal recovery and interface chips. These interface chips are themselves already packaged when attached to the transceiver PCB. A good example of an industry standard design is the dominant SFF/SFP transceiver, as defined by the SFF Committee.

As is known to those skilled in the art, the design of a TO-can package based device is such that it has to be individually constructed and aligned. As a result the cost of TO-can packaging is disproportionate to the cost of the device that it packages. This is compounded by the additional complexity on the transceiver PCB which has to be assembled and integrated with the TO-can package.

By way of example, a generic TO-can packaged, optoelectrical conversion device 1 is presented in FIG. 1a. Within such a device an optoelectronic device 2, whether a light detector such as a photodiode or a light emitter such as a vertical cavity surface emitting laser (VCSEL), is bonded down to a TO-can package 3. The optoelectronic device 2 is then electrically wire bonded 4 onto electrical connections (not shown) such as pins or tracks. Under normal circumstances, there is little additional room for any but the smallest of additional components within the standard size TO-can package 3, so most drive and interface components are required to reside on the transceiver PCB.

Any optical signal 5 to or from the optoelectronic device 2 has to be focussed by means of a lens, or other similar system, that guides the light into a fibre 6. In the case of a TO-can package 3, this is typically a ball lens 7 that is part of an actively aligned cap assembly.

Alternatively, there are newer MEMs approaches to the integration of optoelectronics that are known to those skilled in the art, a generic depiction of which is presented schematically in FIG. 1b. In this type of design, the optoelectronic device 2 is again wire bonded 4 down to tracks (not shown) on a wafer scalable carrier 8. This carrier 8, typically a silicon microbench, or similar technology, allows for the construction of pads, tracks and vias. The carrier 8 is then capped with an optically transparent material 9 which serves to protect the optoelectronic device 2 packaged within. The entire device is then actively aligned and bonded down to an alignment jig 10 which serves as an overall reference point with respect to the fibre connector. Under normal circumstances, there is some space for additional components within the MEMs package, however most drive and interface components still reside on the transceiver PCB for thermal reasons.

Any optical signal 5 to or from the optoelectronic device 2 has to be focussed by means of a lens, or other similar system, that guides the light into the fibre 6. In the case of a MEMs device, this is typically a hemispherical lens 11 that is placed using active alignment techniques onto the transparent cap 9.

It will be appreciated that the design of FIG. 1b has many variants which include placing a ball lens in the cavity with the optoelectronic device 2, attaching the optoelectronic device 2 using flip-chip bonding techniques directly to the transparent cap 9 or fabricating the optoelectronic devices 2 directly onto on the transparent cap 9.

### SUMMARY OF INVENTION

According to a first aspect of the present invention there is provided an optical wafer the optical wafer comprising a transparent substrate embedded within which is at least one optical channel.

Such an optical wafer is resilient to dust, dirt, contaminants and further processing because of the embedded nature of the optical channel. Furthermore, the embedded nature of the optical channel makes the wafer an ideal carrier for an optical sub-assembly (OSA).

Most preferably the optical wafer comprises at least one reference fiducial.

The incorporation of the reference fiducial provides the optical wafer, and any subsequent OSA with passive alignment facility that means that alignment errors do not stack.

Preferably the at least one reference fiducial is embedded within the transparent substrate. Alternatively the at least one reference fiducial is located on an external surface of the transparent substrate.

Optionally the at least one optical channel comprise a refractive optical component. Alternatively, the at least one optical channel comprise a waveguide optical component.

Most preferably embedded within the optical wafer are two or more optical channels and an embedded crosstalk reduction trench located between the two or more optical channels.

The presence of the crosstalk reduction trench significantly reduces the detrimental effects of crosstalk between the two or more channels.

Preferably the transparent substrate comprises a transparent layer and a transparent cap.

Optionally at least one of the two or more optical channels comprises a refractive optical component located within the transparent layer.

Optionally at least one of the two or more optical channels comprises a refractive optical component located within the transparent cap.

Optionally the at least one reference fiducial comprises a first fiducial section located within the transparent layer and a second fiducial section located within the transparent cap.

Optionally the crosstalk reduction trench comprises a first trench located within the transparent layer and a second trench located within the transparent cap.

Optionally the crosstalk reduction trench comprises an optically opaque material. Alternatively, the crosstalk reduction trench comprises an optically diffuse material. In a yet further alternative the crosstalk reduction trench comprises an optically reflective material.

According to a second aspect of the present invention there is provided an optical sub-assembly (OSA), the optical sub-assembly comprising an optical carrier wherein the optical carrier comprises an optical wafer in accordance with the first aspect of the present invention.

Incorporating the optical wafer of the first aspect of the present invention allows for the OSA to be assembled directly on the optical wafer. This is only feasible because of the resilience of the optical system design. Additional features of the OSA can be structured or fabricated on the optical wafers without the need for active alignment of lenses as a post process due to the presence of the reference fiducial.

Most preferably the OSA further comprises at least one mechanical alignment hole which extends through the transparent substrate. The presence of the mechanical alignment holes provide a female to mate with the male of a connector to be attached to the OSA.

Preferably the OSA further comprises an electrical connection layer processed on a first surface of the transparent substrate.

Optionally the OSA further comprises an anti-reflection coating processed on a second surface of the transparent substrate.

Most preferably the OSA further comprises an optoelectronic device electrically connected to the electrical connection layer.

Optionally the OSA further comprises a glob top arranged to provide physical protection to at least part of the optoelectronic device.

Preferably the glob top comprises a hydrophobic material.

Alternatively the OSA further comprises a shell wafer arranged to provide physical protection to at least part of the optoelectronic device.

Most preferably the shell wafer comprises sealing ring such that the shell wafer hermetically seals the optoelectronic device within a central cavity.

Preferably the central cavity is filled with an inert gas.

Optionally one or more components of the optoelectronic device are mounted on an anterior surface of the shell wafer such that they do not make direct contact with the optical wafer.

Preferably the central cavity comprises one or more shelves wherein the anterior surface of the shell wafer corresponding to the one or more shelves lies closer to the optical wafer than the anterior surface of the remainder of the central cavity.

Most preferably a thermal interface material is located on the one or more shelves.

Optionally the shell wafer comprises a flex based shell wafer. Optionally the flex based shell wafer comprises a heat sink thermally connected to a posterior surface of the flex based shell wafer.

Alternatively the shell wafer comprises a ball grid array (BGA) based shell wafer.

According to a third aspect of the present invention there is provided an optical sub-assembly wafer wherein the optical sub-assembly wafer comprises one or more OSA in accordance with the second aspect of the present invention.

According to a fourth aspect of the present invention there is provided a method of production of an optical wafer the method comprising the step of embedding at least one optical channel within a transparent substrate.

Most preferably the step of embedding at least one optical channel within the transparent substrate comprises the steps of
1) processing a transparent layer so as to provide the transparent layer with at least one reference fiducial and at least one lens;
2) bonding a transparent cap to the transparent layer.

Preferably the method further comprises the step of processing the transparent cap so as to provide the transparent cap with at least one reference fiducial.

Preferably the step of bonding the transparent cap to the transparent layer results in the alignment of the at least one reference fiducials of the cap and the layer.

Optionally the step of processing the transparent cap comprises the step of providing a lens trench suitable for locating with the at least one lens of the transparent layer.

Optionally the step of processing the transparent cap comprises the step of providing at least one isolation planes suitable for ensuring that light is not reflected back along the optical channel.

Most preferably the step of processing the transparent cap comprises providing the transparent cap with at least one lens such that when bonded to the transparent layer the optical wafer comprises two or more embedded optical channels.

Most preferably the method further comprises the step of processing the transparent layer and transparent cap so as to provide a crosstalk reduction trench between the two or more embedded optical channels.

Preferably this step comprises the processing of a first trench within the transparent layer and a second trench within the transparent cap the first and second trenches being aligned when the transparent cap is bonded to the transparent layer.

Optionally the first and/or second trenches are filled with an optically opaque material prior to bonding.

Alternatively, the step of embedding at least one optical channel within the transparent substrate comprises the step of processing the transparent substrate so as to form at least one sub-surface optical channel.

Preferably the transparent substrate is further processed so as to provide at least one reference fiducial.

Preferably, the step of processing the at least one reference fiducial comprises the steps of:
1) applying a high powered laser to process a first region of the transparent substrate; and
2) etching the transparent substrate so as to remove the processed first region of the transparent substrate.

Optionally the processing the transparent substrate so as to form at least one sub-surface optical channel comprises the step of focussing a low powered laser within at least one subsurface region of the transparent substrate so as induce a thermal refractive index change within the subsurface region.

Optionally the induced thermal refractive index change is controlled so as to process a lens within the subsurface region. Alternatively, the induced thermal refractive index change is controlled so as to process a waveguide within the subsurface region.

Preferably the step of embedding at least one optical channel comprises processing the transparent substrate so as to provide the transparent substrate with two or more embedded optical channels.

Most preferably the method of production of an optical wafer further comprises the step of processing a subsurface region of the transparent substrate so as provide a crosstalk reduction trench between the two or more embedded optical channels.

Preferably the step of processing the subsurface region of the transparent substrate so as provide a crosstalk reduction trench comprises the step of focussing a high powered laser within the subsurface region. This method produces a crosstalk reduction trench that comprises a highly diffusing or opaque region of the transparent substrate.

Alternatively, the step of processing the subsurface region of the transparent substrate so as provide a crosstalk reduction trench comprises the step of focussing a low powered laser within the subsurface region. This method produces a crosstalk reduction trench that exhibits a different refractive index from the non processed regions of the transparent substrate.

According to a fifth aspect of the present invention there is provided a method of producing an optical sub-assembly the method comprising the steps of:
1) applying an electrical connection layer to an optical wafer in accordance with the first aspect of the present invention;
2) processing the optical wafer so as to provide at least one mechanical alignment pin hole; and
3) attaching an optoelectronic device to the electrical connection layer.

Optionally the method of producing an optical sub-assembly further comprises the step of bonding a glob top to the optical wafer so as to provide physical protection to at least part of the optoelectronic device.

Preferably the method of producing an optical sub-assembly further comprises the step of bonding a shell wafer to the optical wafer so as to provide physical protection to at least part of the optoelectronic device.

Most preferably the method of producing an optical sub-assembly further comprises the step of cutting the optical wafer so as to singulate the optical sub-assembly.

### BRIEF DESCRIPTION OF DRAWINGS

Aspects and advantages of the present invention will become apparent upon reading the following detailed description and upon reference to the following drawings in which:

FIG. 1 presents a schematic representation of:
(a) a TO-can packaged, prior art, optical sub-assembly; and
(b) a MEMS based, prior art, optical sub-assembly;

FIG. 2 presents a schematic representation of:
(a) a dual layer optical wafer; and
(b) a single layer optical wafer;
with embedded refractive optical channels in accordance with an aspect of the present invention;

FIG. 3 presents a schematic representation of:
(a) a first; and
(b) a second embodiment
of single layer optical wafer with embedded waveguide optical channels in accordance with an aspect of the present invention;

FIG. 4 presents a schematic representation of the first stage of production of the dual layer optical wafer with embedded refractive optical channels of FIG. 2(a);

FIG. 5 presents a schematic representation of the second stage of production of the dual layer optical wafer with embedded refractive optical channels of FIG. 2(a);

FIG. 6 presents a schematic representation of the third stage of production of the dual layer optical wafer with embedded refractive optical channels of FIG. 2(a);

FIG. 7 presents a schematic representation of the steps of a first stage of production of an optical sub-assembly (OSA) in accordance with an aspect of the present invention (Sacrificial layers, AR layer and electrical connections layer);

FIG. 8 presents a schematic representation of the steps a second stage of production of the OSA, namely the processing of mechanical alignment pin holes;

FIG. 9 presents a schematic representation of a third stage of production of the OSA, namely the attachment of an optoelectonic device;

FIG. 10 presents a schematic representation of a final stage of production of the OSA, namely the attachment of a glob top to the OSA;

FIG. 11 presents a schematic representation of:
(a) a first;
(b) a second;
(c) third; and
(d) fourth embodiment of a shell wafer suitable for use in an alternative final stage of production of the OSA;

FIG. 12 presents a schematic example of a flex based OSA, namely shell wafer of FIG. 11(c) bonded the optical wafer of FIG. 2(a);

FIG. 13 presents a schematic example of a BGA based OSA, namely shell wafer of FIG. 11(d) bonded the optical wafer of FIG. 2(a); and

FIG. 14 presents an example of a complete BGA based OSA wafer that has just undergone singulation.

### DETAILED DESCRIPTION

The following sections describe two distinct designs of optical wafer which form the central building block for the later described optical sub-assemblies (OSAs), namely:
1) an optical wafer with embedded refractive optical channels 12; and
2) an optical wafer with embedded waveguide optical channels 13.

The embedded refractive optical channel design relies on a refractive index change to lens light between an optoelectronic device and a fibre, whereas the embedded waveguide channel design manipulates light by effectively writing a fibre within the optical wafer.

To assist clarity of understanding, the following described embodiments present two channel assemblies, transmit channel C1 and receive channel C2, designed for MT-RJ connectors. It should be noted however, the later described OSA are specifically meant to be scalable in two dimensions enabling arrays such as 1×12, 6×12 or perhaps even greater, and as such the optical wafers 12 and 13 are scalable in a similar manner. In certain circumstances it may even be envisaged to produce a single channel OSA.

It will also be appreciated that, under normal commercial circumstances, the construction of all optical channels would be identical. For illustrative purposes however, some of the described embodiments below show design variations between the two channels C1 and C2.

The described embodiments do not state lens radii, sidewall steepness nor material type and thickness. It will however be appreciated by those skilled in the art that such parameters need to be calculated, as appropriate, for each different application.

The terms “transparent” and “opaque” employed throughout the following description relate to the optical properties of particular components of the device relative to the wavelength of the light generated by the associated light sources.

Optical Wafer with Embedded Refractive Optical Channels

FIG. 2(a) presents a schematic representation of a dual layer optical wafer 12a, with embedded refractive optical channels, C1 and C2. Dual layer optical wafer 12a can be seen to comprise a transparent substrate made up of a transparent layer 14 and a transparent cap 15 both having a thickness of −0.5 mm. Both of these layers are significantly larger than the schematic representations of FIG. 2(a), as indicated by the cut away edges 16. The same holds true for the various other layers described throughout the remainder of the specification.

Methods of production of the transparent layer 14 and cap 15 are described in further detail below. It can be seen however that the adjacent surfaces of the layer 14 and the cap 15 are preformed with two negative reference fiducial points 17a, 18a, 17b and 18b, a lens, 19a and 19b, and a crosstalk reduction trench 20a and 20b, such that when bonded together the dual layer optical wafer 12a comprises two embedded channels, C1 and C2 which are optically isolated by the crosstalk reduction trench 20.

In this embodiment each channel C1 and C2 comprises a lens 19 and a dedicated reference fiducial 17 and 18.

Incorporating the plurality of fiducial points 17a, 18a, 17b and 18b provides a number of advantages to this design. Firstly, wafer to wafer bonding requires two spaced reference points to ensure the accuracy of rotational alignment. Secondly, an alignment feature should always be close to an optical channel (C1 or C2) to enable accurate flip-chip bonding with reference to that channel. The further away the alignment feature is located, the less accurate the alignment will be.

An alternative embodiment of the optical wafer with embedded refractive optical channels is presented in FIG. 2(b). In this embodiment the optical wafer 12b comprises a single, optically transparent substrate having a thickness of ˜1 mm. The single layer optical wafer 12b can be seen to similarly comprise two embedded channels, C1 and C2 which are optically isolated by a crosstalk reduction trench 20. In this embodiment however, channel C1 comprises a negative lens 19c while channel C2 comprises a positive lens 19d, and the channels share a common reference fiducial 21 located on an external surface of the optical wafer 12b.

Optical Wafer with Embedded Waveguide Optical Channels

FIG. 3(a) presents a schematic representation of a first embodiment of an optical wafer 13a, with embedded waveguide optical channels, C1 and C2. In this embodiment the optical wafer 13b comprises a single, optically transparent substrate having a thickness of ˜1 mm. The two embedded channels, C1 and C2 are again optically isolated by a crosstalk reduction trench 20.

In this embodiment however, channels C1 and C2 each comprises an embedded waveguide 22a and a dedicated reference fiducial, 21, located on an external surface of the optical wafer 13b. The cross section of the embedded waveguides 22a is either circular or square, depending on the processing method.

Incorporating dedicated reference fiducials, 21 again provide the advantage that there is an alignment feature close to each optical channel (C1 or C2) so as to assist with accurate flip-chip bonding with reference to that channel.

An alternative optical wafer 13b, with embedded refractive optical channels, C1 and C2, is presented in FIG. 3(b). In this embodiment channel C2 comprises a waveguide 22b that flares and narrows along its optical path so allowing the waveguide to adjust the beam profile. Optical modelling is employed to adjust the amount of flaring or narrowing to an angle appropriate for any given application. The optical wafer 13b of FIG. 3(b) further differs from the optical wafer 13a, presented in FIG. 3(a), in that and the channels C1 and C2 share a common reference fiducial 21 located on an external surface of the optical wafer 13b.

Sample materials for the production of the abovementioned layer 14, cap 15 and optical wafers 12b and 13 include, but are not limited to, glass, glass ceramic, photoformable glass. It should also be noted that each of the optical wafers 12a, 12b 13a, and 13b are significantly larger than shown in the relevant Figures, as is indicated by the cut away edges 16.

Method of Production of an Optical Wafer with Embedded Refractive Optical Channels

There now follows a detailed description of a number of methods of production of optical wafers 12 with embedded refractive optical channels, C1 and C2.

### Dual Layer Optical Wafer

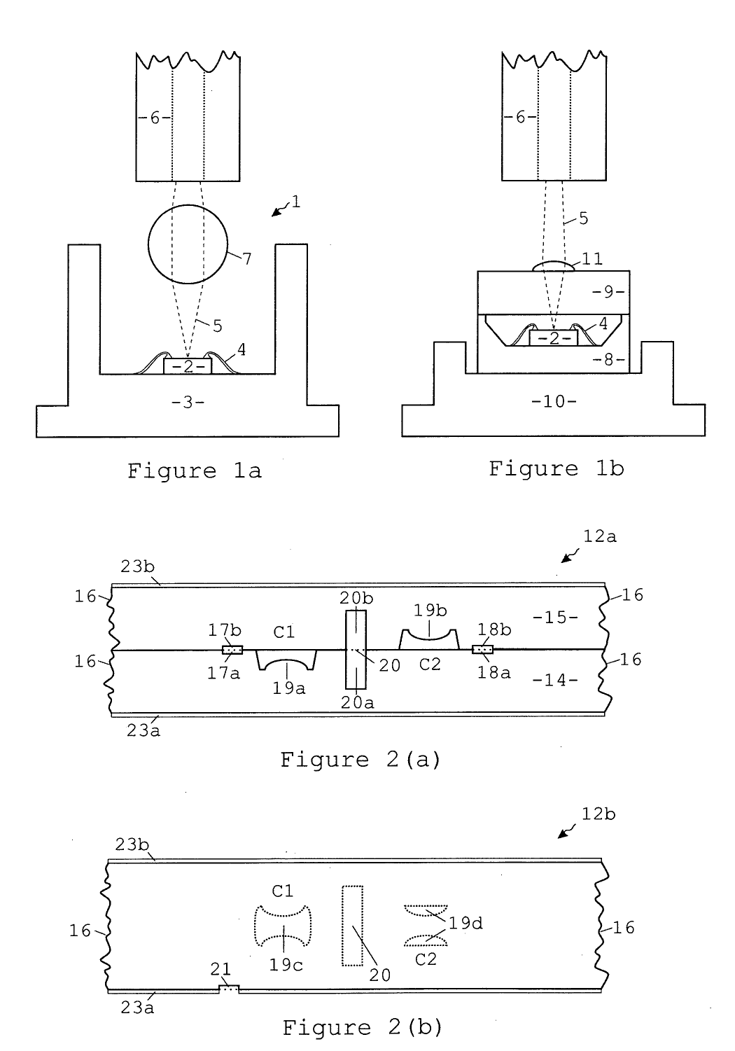

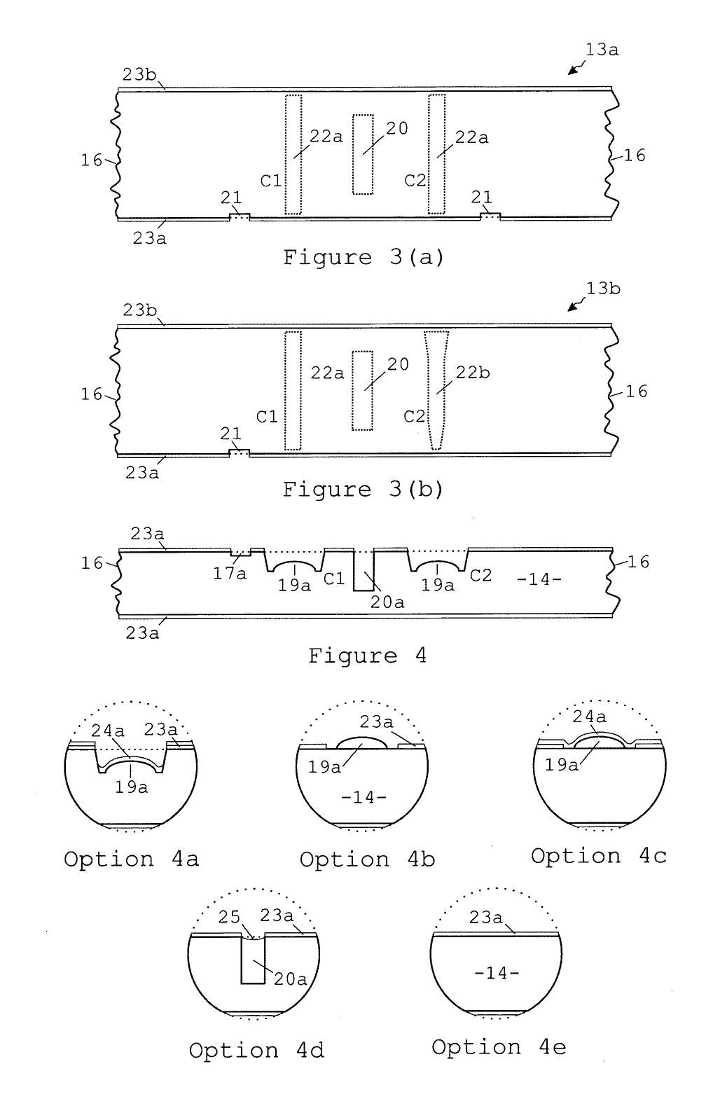

In the first instance a method of production of a dual layer optical wafer 12a is provided with reference to FIGS. 4 to 6.

### Step 1—Transparent Layer

The first stage involves the production of the transparent layer 14, as shown in FIG. 4. Before processing the transparent layer 14, it is prudent to apply a sacrificial layer 23a to the layer 14 to prevent damage or the adhesion of any contaminants. This is especially useful when laser drilling is employed in the production of the optical wafer 12a. Example sacrificial layers 23a include, but are not limited to, photoresists.

Next, the transparent layer 14 is processed with the fiducial point 17a, which act as a reference point for all assembly of the optical wafer 12a. Normally the fiducial point 17a is formed on the same side of the transparent layer 14 as the lenses 19a are to be formed to ensure that alignment accuracy is maintained. However, there are certain circumstances where it is advantageous to form the fiducial point 17a on the opposite or on both sides of the transparent layer 14.

The preferred method is to incorporate a negative fiducial point using techniques such as direct laser writing or an etch. Positive fiducial points by deposition are also feasible if they are on the opposite side to the lenses 19a, but deposition on the same side as the lenses 19a will result in poor wafer to wafer bond quality at a later stage.

It is important to note that there are typically multiple alignment fiducial points 17a across the transparent layer 14. A minimum of two is required for even vaguely accurate alignment.

The optical lenses 19a are then cut with reference to the fiducial point 17a. The preferred method is a first pass using laser cutting, however other methods such as etching may alternatively be employed.

The next step is to create the crosstalk reduction trench 20a. This design of trench 20a is such that total internal reflection is employed to prevent adjacent optical channel crosstalk. Given its depth, fabrication of the trench 20a is preferably done by laser cutting or a fast etch process. It will be appreciated that care should be taken to only go part way through the transparent layer 14 and not to break through to the other side. Doing so would compromise structural integrity for the following processes, and also results in poor tracking as the metals would create teardrops around the resultant holes.

It should be noted that the sidewalls of the crosstalk reduction trench 20a are unlikely to be perfectly straight for a number of practical reasons. The sidewall angle should be adjusted and optically modelled to suit the application. Surface roughness on the sidewalls is however found not to be particularly critical.

The lenses 19a are then smoothed with a final post-process. Processing examples include laser smoothing, thermal annealing, material deposition, chemical etching or moulding of the carrier. This is essential to ensure the quality of the lenses 19a so resulting in low optical coupling losses.

Further optional steps in the production of the transparent layer 14 are provided within the inserts of FIG. 4, namely FIGS. 4a to 4e. In particular:
a) FIG. 4a presents the optional step of depositing of an anti-reflective (AR) coating 24a on top of the lenses 19a so as to further minimise coupling losses;
b) FIG. 4b presents the option of depositing the lenses 19a on top of the transparent layer 14. For example, piezoelectric technologies or micro-syringes could be used to apply an optically tailored polymer, or similar material, with reference to fiducial point 17a. Tuning the polymer's properties would ensure that surface tension forms an appropriate lens 19a. This solution requires an alignment matched up with a trench located within the cap 15. Windows in the sacrificial layer 23 are also need to be removed to ensure adhesion to the transparent layer 14.
c) As presented in FIG. 4c, the optical properties of any deposited lens 19a can also be enhanced by the addition of an anti-reflective (AR) coating 24a. To ensure successful wafer to wafer bonding at a later stage, the thickness of the coating 24a must not exceed the depth of the trench located within the cap 15;
d) FIG. 4d presents the option of having the crosstalk reduction trench 20a backfilled with an optically opaque material 25. This improves the optical isolation of channels C1 and C2. Care must be taken during this process to ensure that the lenses 19a are not contaminated with any of optically opaque material 25. In addition, to ensure successful wafer to wafer bonding at a later stage, the opaque material 25 must not exceed the height of the trench 20a. Deposition of the opaque material 25 is carried out using micro-syringe techniques, or other similar technology; and
e) FIG. 4e presents schematically the case where the lens 19a is not formed on the transparent layer 14. In this case, the matching lens would be formed on the cap 15. Such a design is ideal for duplex systems where the cap 15 and the transparent layer 14 are identical and the lens 19a needs to be as close as possible to the optical source, be it an emitter or a fibre e.g. see the above embodiment of FIG. 2.

### Step 2—Cap

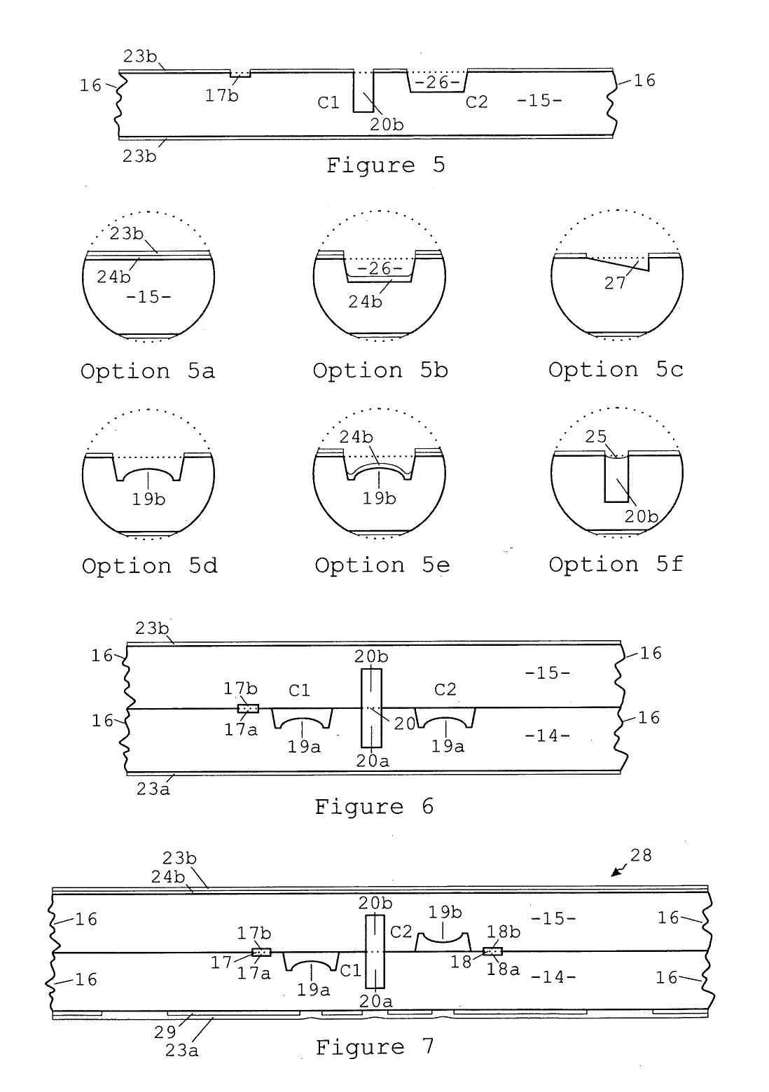

The second stage of production of the dual layer optical wafer 12a involves the production of the cap 15, as shown in FIG. 5. Before further processing the cap 15, it is again prudent to apply a sacrificial layer 23b to the cap 15 to prevent damage or the adhesion of any contaminants. This is especially useful when laser drilling is employed.

Next, the cap 15 is processed with alignment fiducial 17b which acts as a reference point for all assembly of the cap 15. This is carried out in a similar manner as discussed above with respect to the alignment fiducial 17a of the transparent layer 14.

More often than not, there will be nothing cut in the cap as shown in channel C1 of FIG. 5. However, if a lens 19a was deposited on the surface of the transparent layer 14 then a matching lens trench 26 is required, see channel C2 of FIG. 5. The preferred method for producing the lens trench 26 is a first pass using laser cutting, however other methods such as etching may alternatively be employed. The position of the lens trench 26 is cut with reference to alignment fiducial 17b.

The next step is to create the crosstalk reduction trench 20b. This reduction trench 20b is produced, and functions in a similar manner to the reduction trench 20a described above in connection with the transparent layer 14. Care should again be taken to ensure that the reduction trench 20b does not go all the way through the cap 15 otherwise the structural integrity may be compromised given that a connector will be butted up to the cap 15. This may also result in a poor surface layer for post processing such as, but not limited to, polishing or AR coating.

If the lens trench 26 is present, it will need to be smoothed with a final post-process. Processing examples include laser smoothing, thermal annealing, material deposition, chemical etching or moulding of the carrier. This is essential to ensure the quality of the optical interface so providing low optical coupling losses.

In a similar manner to that described above in relation to the transparent layer 14, further optional steps in the production of the cap 15 can be incorporated. These additional steps are presented schematically within the inserts of FIG. 5, namely FIGS. 5a to 5f. In particular:
a) FIG. 5a presents the optional step of depositing of an anti-reflective (AR) coating 24b on top of the cap before deposting the sacrificial layer 23b to ensure that there is minimal optical loss at the interface of the transparent layer 14 and the cap 15. Care should obviously be taken to ensure that the anti-reflective (AR) coating 24b is compatible with wafer to wafer bonding;
b) Optionally, if the optical coupling losses are high at the interface within the lens trench 26 then an AR coating 24b can also be added to the trench 26, see FIG. 5b;
c) Certain optical designs require the incorporation of an optical isolation plane 27 to ensure that light is not reflected back along the optical path, see FIG. 5c. The isolation plane 27 is again cut with reference to fiducial 17b. The preferred method is a first pass using laser cutting, however other methods such as etching are found to prove more practical in certain circumstances. The isolation plane 27 should also be smoothed with a final post-process. Processing examples include laser smoothing, thermal annealing, material deposition, chemical etching or moulding of the carrier. This is essential to ensure the quality of the isolation plane and results in low optical coupling losses;
d) In certain situations, the divergence of the optical beam may be such that a bi-conic lens is required. In this case, as presented schematically in FIG. 5d, an optional lens 19b is cut with reference to fiducial 17b. The preferred method is a first pass using laser cutting, however other methods such as etching are found to prove more practical in certain circumstance. Lens 19b is also required to be smoothed with a final post-process. Processing examples include laser smoothing, thermal annealing, material deposition, chemical etching or moulding of the carrier. This is essential to ensure the quality of the lens 19b and results in a low optical coupling loss.
e) If the losses associated with lens 19b prove consistently high, then an anti-reflective (AR) coating 24b can be introduced on top of the lens 19b, see FIG. 5e.
f) Finally, FIG. 5f presents the option of also having the crosstalk reduction trench 20b backfilled with the optically opaque material 25 so as to take advantage of the previously discussed benefits of such a feature.

### Step 3—Bonding

FIG. 6 shows the next stage in the process wherein the cap 15 is bonded on top of the transparent layer 14. This process first requires the removal of the top sacrificial layers 23a and 23b of the transparent layer and the cap 15. Depending on the cleaning process used, the sacrificial layers 23a and 23b on the bottom surfaces of the transparent layer 14 and the cap 15 may also be required to be removed. It is often prudent re-apply the bottom sacrificial layers 23a and 23b to prevent damage or the adhesion of any contaminants during the wafer to wafer bond process.

The final step to reach the configuration shown in FIG. 6 is to use a wafer to wafer bond process to attach the transparent layer 14 and the cap 15. Depending on the particular material used for the transparent layer 14 and the cap 15, an appropriate bond process is chosen. Choices include, but are not limited to, anodic bonding where an electrical carrier exists in the material, intermediate layers such as solder, adhesive or glass frit, or direct bonding. To assist in this step, the fiducials 17a and 17b of the transparent layer 14 and the cap 15 are employed to correctly align these components.

### Single Layer Optical Wafer

Methods of production of the single layer optical wafer 12b of FIG. 2(b) are now described. As discussed previously, it is prudent to initially apply a sacrificial layer 23a and 23b before processing the single layer optical wafer 12b so as to prevent damage or the adhesion of any contaminants.

There are then two distinct methods employed for the processing of the wafer 12b. The choice of method depends upon the material from which the optical wafer 12b is made however, both employ laser processing techniques.

Method 1—non-photoformable optical wafers

The first method described is particularly suited when the optical wafer 12b comprises a non-photoformable glass. Processing is then carried out with a high power laser, for example a femtosecond pulsed laser. By varying laser power and focus different features can be cut. Low power pulses will cause a thermal refractive index change that can be focussed subsurface to create optical structures. Higher power pulses cause thermal expansion and microfine cracking to occur. Cracked glass etches preferentially, allowing the cracked glass to be washed away.

The initial stage of producing the single layer optical wafer 12b involves the processing of fiducial point 21, which act as a reference point for all assembly of the optical wafer 12b. Normally the fiducial 21 is created on the same side to that from which the wafer is being processed by the laser to ensure that alignment accuracy is maintained, however there are certain circumstances where it is advantageous to form fiducials 21 on the opposite, or on both side of optical wafer 12b. The preferred method is to produce a negative fiducial 21 formed by the application of the high powered laser. Since the laser power cracks the optical wafer 12b then subsequent etching allows the fiducial 21 to be formed in a highly controlled manner.

The second stage of the process involves the writing of the negative lens 19c in channel C1 and the positive lens 19d in channel C2, both being written with reference to negative fiducial 21. To process these features low power light from the laser is focussed subsurface within the optical wafer 12b thus enabling the resultant thermal refractive index changes to be employed in a controlled manner so as to create the required optical structures.

The third stage of the process is to create the crosstalk reduction block 20. The location of the crosstalk reduction block 20 is carefully aligned with reference to negative fiducial 21 and formed by employ high laser power so as to create a highly diffusing area within the optical wafer 12b. Alternatively, this third stage may be carried out by employing low laser power so as to create an area of significant refractive index change. Under certain circumstances this may be sufficient to reduce the crosstalk between channels C1 and C2 to a commercially acceptable level.

Method 2—photoformable optical wafers

The second method is particularly suited when the optical wafer 12b comprises a photoformable glass, and in particular a ceramicizable glass. By varying the processing laser's power and focus, different features can be processed. At low power, the refractive index of the glass is again thermally changed. At higher power, the glass will ceramicize, becoming opaque and can be etched significantly faster than the unaffected glass thus allowing it to be preferentially dissolved away.

The initial stage of producing the single layer optical wafer 12b involves the processing of fiducial point 21, which act as a reference point for all assembly of the optical wafer 12b. The preferred method is to produce a negative fiducial 21 formed by the application of the high powered laser. Since the laser power ceramicizes the optical wafer 12b then subsequent etching allows the fiducials 21 to be formed in a highly controlled manner.

The second stage of the process involves the writing of the negative lens 19c in channel C1 and the positive lens 19d in channel C2, both being written with reference to negative fiducial 21. To achieve this low power light from the laser is again focussed subsurface within the optical wafer 12b thus enabling the resultant thermal refractive index changes to be employed in a controlled manner so as to create the required optical structures.

The third stage of the process is to create the crosstalk reduction block 20. The location of the crosstalk reduction block 20 is carefully aligned with reference to negative fiducial 21 and formed by employ high laser power so as to create a highly opaque area within the optical wafer 12b. Alternatively, this third stage may be carried out by employing low laser power so as to create an area of significant refractive index change. Under certain circumstances this may be sufficient to reduce the crosstalk between channels C1 and C2 to a commercially acceptable level.

Method of Production of an Optical Wafer with Embedded Waveguide Optical Channels

There now follows a detailed description of a number of methods of production of optical wafers 13 with embedded waveguide optical channels, C1 and C2 e.g. see FIGS. 3(a) and 3(b).

As previously discussed, before processing it is normally prudent to apply sacrificial layers 23a and 23b to the optical wafer 13.

The first processing stage is again to create the alignment fiducials 21 which act as reference points for all the subsequent assembly. These features can be created in an identical manner to that described previously with respect to the optical wafers 12 with embedded refractive optical channels, C1 and C2, see above methods 1 and 2.

The second stage of the process involves the writing of the optical waveguides 22a in channels C1 and C2. Both the optical waveguides 22a are written with reference to negative fiducial 21. To achieve this low power light (whether employing non-photoformable or photoformable materials) is focussed subsurface within the optical wafer 12b thus enabling the resultant thermal refractive index changes to be employed in a controlled manner so as to create the required optical structures. As discussed previously with respect to FIG. 3, the waveguide structures 22a can be circular or square in cross section and may include flares that narrow the waveguide to adjust the beam profile for input and output light.

The third processing stage is again to create the crosstalk reduction block 20 which act to prevent optical cross talk between the channels C1 and C2. This feature is created in an identical manner to that described previously with respect to the optical wafers 12 with embedded refractive optical channels, C1 and C2, see above methods 1 and 2.

Below are a number of significant points to note in relation to the optical wafer 12b, 13a, and 13b and the above described methods of production:
1) positive fiducials, by deposition, are feasible in this design and could even be deposited pre laser processing if their survival through all subsequent processes can be guaranteed;
2) the surface roughness at the transition point between different refractive index layers is highly critical in these designs and must be carefully monitored otherwise it these can lead to excessive optical losses;
3) there must be a significant unprocessed layer of glass surrounding the negative lens 19c or waveguide 22a in channel C1; the positive lens 19d or waveguide 22a or 22b in channel C2; and the crosstalk reduction block 20 so as to prevent any subsequent etch steps from removing these features. With respect to the crosstalk reduction block 20, such removal may not compromise the overall operation of the device however, it is likely that it would compromise any hermeticity in the device cavity as well as weakening the physical strength of the substrate near a flip-chip bond point.
4) the sidewalls of the crosstalk reduction block 20 are unlikely to be perfectly straight for a number of practical reasons. However, their diffusing or opaque nature means that this is not a particular problem, nor is their surface roughness.

### Optical Sub-assembly (OSA)

There now follows a detailed discussion of the assembly of an OSA 28 in accordance with an aspect of the present invention. It will be appreciated by those skilled in the art that any of the above described optical wafers 12a, 12b, 13a, or 13b may be employed as the carrier for the OSA 28. However, for the purposes of illustration, the following examples are based on employing the dual layer optical wafer 12a of FIG. 1 as the carrier for the OSA 28.

The first processing stage involves the step of removing the sacrificial layers 23a and 23b, if present on the external surfaces of the dual layer optical wafer 12a. This gives a clean surface on which to define subsequent layers.

The second step is to apply an electrical connection layer, shown as layer 29 within FIG. 7. Electrical connection layer 29 in practice is a complex electrical pattern, typically defined using photolithography, and deposited using an electrically conductive material.

Depending on the carrier used, additional layers may be required such as adhesion layers. Alignment of the electrical connection layer 29 is achieved with respect to fiducials 17 and 18, depending on design. Since subsequent processing is required, it is recommended that sacrificial layers 23a and 23b are reapplied to protect the connections. The electrical connections are defined at this point given that it will not be possible to pattern the wafer post drilling.

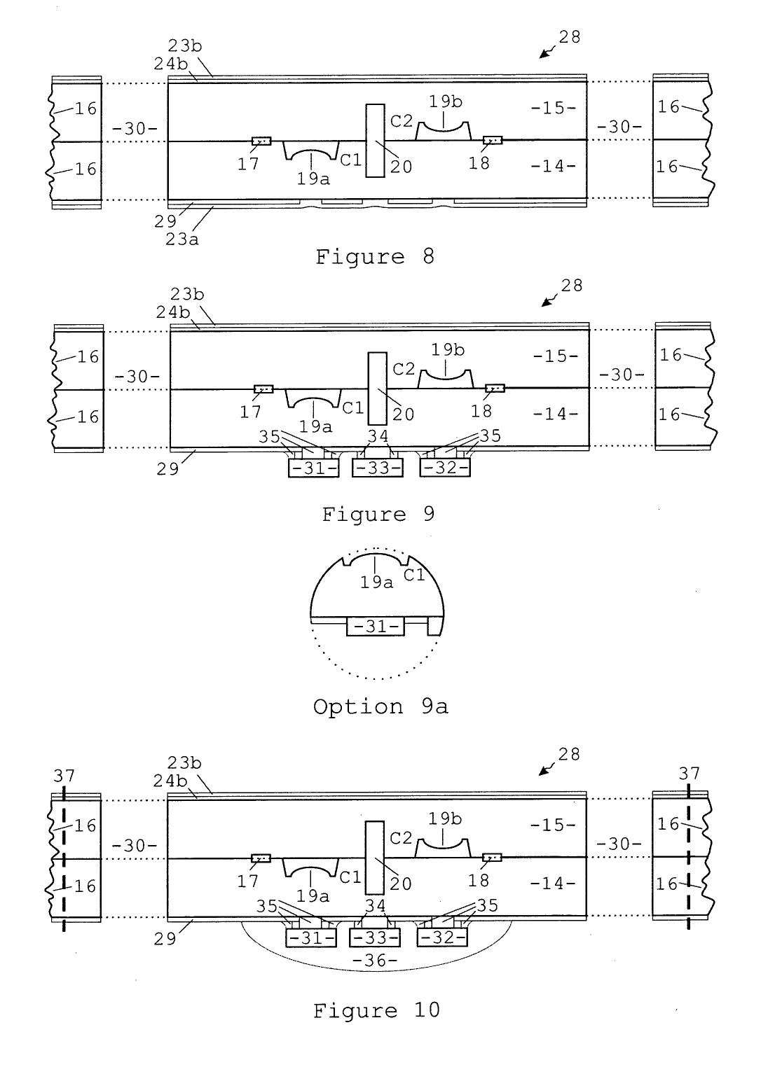

Before applying sacrificial layer 23b, an optional process step is to deposit an AR coating 24b to reduce back reflection into the MT connector and improve overall device performance. As this is a bulk coating no alignment is necessary. The AR coating 24b type should however be chosen bearing in mind that this layer will be drilled through as described below with reference to FIG. 8.

The second stage in the production of OSA 28 involves the cutting of mechanical alignment pin holes 30 which subsequently act as the guides for an MT connector. The positions of the mechanical alignment pin holes are set with reference to fiducials 17 and 18 and the preferred method of production is by laser drilling given the depth of holes required. There are three distinct laser drilling methods that can be used depending on the carrier material:
1) if the carrier is not a photoformable material, a nanosecond laser can be employed to ablate the material. This technique is not optimal and may cause localised wafer damage under certain circumstances, but it is relatively fast. Slower femtosecond lasers give higher tolerances and less damage to the wafer but may take significantly longer to complete the task;
2) if the carrier is a photoformable material, the material can be ceramicized right the way through the wafer. An etch can then be used to remove the material, given that it etches preferentially, and will resulting smooth the sidewalls; and
3) the third, and preferred method regardless of material type, is to process a ring around the edge of the hole using a high powered laser. A subsequent etch step will then remove the damaged material, causing the remaining central cylinder to fall out. This method provides the ability to use slower but more accurate laser machining to maintain high levels of tolerance yet still be compatible with volume production.

All of the machining methods described above are likely to result in a sloped sidewall for the mechanical alignment pin holes 30. This must be carefully controlled, but may be used beneficially as a guide for the mechanical contact, if done correctly.

Laser machining of the dual layer wafer design 12a must take into account the bond layer between the transparent layer 14 and the cap 15, and any changes to material properties, or adhesive layers present that may need to be drilled through.

Further, alternative techniques for the formation of the mechanical alignment pin holes 30 include mechanical drilling/grinding whether with bit, sand or liquid, or moulding/performing of the wafer.

Although the above described embodiments comprise two mechanical alignment pin holes 30 aspects of the present invention are not limited to this number. It will be appreciated by those skilled in the art that advantages will be achieved with the incorporation of one or more mechanical alignment pin holes 30.

FIG. 9 describes a third stage in assembly of the OSA 28. In this stage the protective sacrificial layer 23a is removed, allowing access to the electrical connections layer 29. This enables an optoelectronic die, namely emitter 31 and detector 32 and a transimpedance amplifier 33 to be placed using flip-chip methods and attached with solder/stud bumps 34, or equivalent. In practice the preferred method is to employ gold stud bumping as this makes the device resistant to a solder reflow process. The fact that the optical features are embedded gives the carrier sufficient stability to withstand the flip-chip process. The optoelectronic components 31, 32, and 33 are typically low power elements and therefore do not normally require heat-sinking. Alignment of all of these components 31, 32, and 33, is carried out with reference to the fiducials 17 and 18, and therefore the registration accuracy is high with respect to the embedded lenses 19a and 19b.

Underfill 35 may be also be used to improve optical coupling and general stability of the OSA 28.

Optionally, as shown in insert FIG. 9a, components 31, 32, and 33 may be fabricated directly on the surface of the optical wafer 12a. This would generally need to be done before the mechanical alignment holes 30 are drilled. Care will therefore need to be taken that the components are not damaged during drilling. This is why the previously described flip-chip method is the preferred embodiment.

Importantly, it should be noted that the alignment of the entire system is based upon the tolerances of the assembly equipment. Alignment is always to reference one or more reference fiducials 17 and 18, depending on design. Therefore the design is unique in that tolerance errors do not stack. This passive methodology is unusual in the field of optoelectronics.

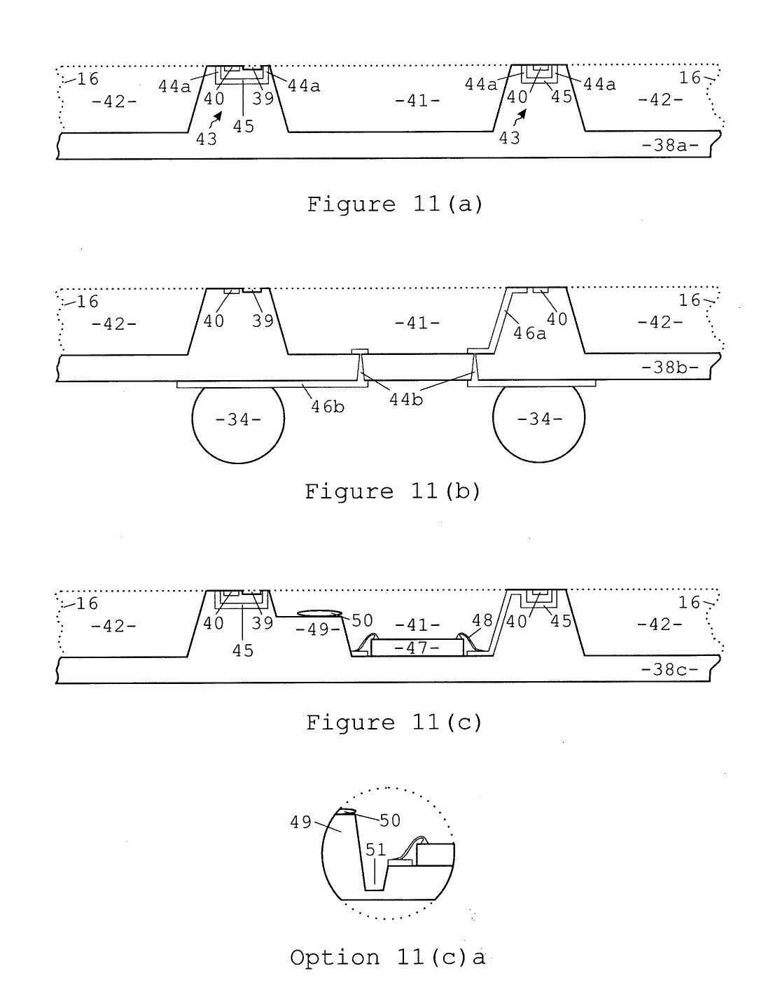

For many practical applications the design of the OSA 28 is completed by the addition of a glob top 36, as presented in FIG. 10. It is preferable for the glob top 36 to be hydrophobic so as to minimise infant mortality rates resulting from water ingress. The devices are then singulated, as represented schematically by the dashed lines 37, and electrical connections are flex bonded at an appropriate point on the electrical tracking of the electrical connection layer 29 that is not covered by the glob top 36.

In an alternative, and indeed preferred embodiment, the next stage in the construction of the OSA 28 is the addition of a shell wafer 38. The shell wafer 38 is designed to give a partially, or fully hermetic seal, and can also be used to add further functionality to the device e.g. function as a heat sink, as described in further detail with reference to FIGS. 11 to 13.

FIG. 11(a) show a first example of a shell wafer 38a suitable for completing the OSA 28. As with the previously described optical wafers 12 and 13, this wafer is significantly larger than shown as is again represented by the cut away edges 16. The processing of shell wafers is known to those skilled in the art and can be achieved by existing technologies such as a silicon microbench, high or low temperature co-fired ceramic or any other similar micro-circuit capable technology. Importantly, however, is the fact that all processing of the shell wafer is done with reference to a single point 39 which acts as a common fiducial and will ultimately be aligned with fiducials (17, 18 or 21 depending on design).

To complete the OSA 28 the shell wafer 38a has four basic requirements, namely.
1) there is a sealing ring 40 or similar that can be used to bond the shell wafer 38a to the optical wafers 12 and 13. The quality of seal, and thereby hermeticity, will be determined by the technology used, for example solder, BCB, glass frit or adhesive. In addition, direct bonding technologies, such as anodic bonding, could alternatively be employed if the optical wafers 12 and 13 and shell wafer 38a are chosen correctly. The sealing ring 40 is essentially a layer that narrows only to allow electrical connections to pass. It should be designed so that it does not short the electrical connection layer 29 on contact;
2) there is a central cavity 41, enclosed by the sealing ring 40, which contains all the components that require to be hermetically sealed. The central cavity 41 is normally cut using a fast and bulk process, such as, but not limited, to an etch. The presence of the central cavity 41 is found to prolong the life of all the contained components and therefore allows harsh environment usage. It is preferable for the central cavity 41 to be filled with an inert gas such as, but not limited to, N₂.
3) there exist surrounding cavities 42 which can be created at the same time as the central cavity 41 using the same etching process. These surrounding cavities 42 allow for easy singulation of the OSA 28 and provide space for long pins to protrude into, or even through, the shell wafer 38a, depending on design.
4) there is an electrical path 43 out of the shell wafer 38a that enables connection to external components. The illustrated electrical paths 43 move vertically using vias 44a to move past the sealing ring 40 and then a subsurface track 45 to move horizontally. The points at which the electrical paths 43 reach the surface of the shell wafer 38a are designed for bonding to the existing electrical tracks on the electrical connection layer 29.

An alternative shell wafer 38b is shown in FIG. 11(b). In this embodiment electrical tracks 46a run down to the thinnest point of the shell wafer 38b and then vias 44b are employed to move the signal through to electrical tracks 46b processed onto the posterior surface of the shell wafer 38b. These tracks 46b are in turn connected to solder balls 34, or similar, which ultimately allow attachment to a printed circuit board (PCB). The solder balls 34 can be arranged to form a standard ball grid array (BGA) design.

There are two additional options that can be added to the shell wafers, see shell wafers 38c and 38d presented in FIG. 11(c) and (d) respectively. FIG. 11(c) shows these options applied to the flex based shell wafer 38a of FIG. 11(a) while FIG. 11(d) shows them applied to a BGA based shell wafer 38b of FIG. 11(b).

The first option is to bond the high power die 47 into the silicon shell wafer 38c and 38d. This physically removes this element from the lower power, and normally temperature sensitive, optoelectronic components 31, 32, and 33. In particular, the shell wafer 38c and 38d provides the necessary heat sinking required by the higher power components (e.g. die 47) as well as a platform to wire bond 48 them to the OSA's 28 electrical connections 43 or 46.

The second option further enhances the OSA's 28 thermal management strategy by incorporating raised portions 49 within the central cavity 41 of the shell wafer 38c and 38d. On assembly, and with the aid of a thermal interface material 50, heat can be sunk from devices 31, 32, and 33 attached to the optical carriers 12. The choice of the thermal interface material 50 is highly critical. If the coefficient of thermal transfer is either too high or too low, there is the risk that heat makes its way from the high power die 47 back into the temperature sensitive components or that insufficient heat is removed from the high power die 47 to allow it to function correctly.

A further option is to combine the raised portions 49 with sunken sections 51, see FIG. 11(c) a that can be used to increase the resistance of the thermal path to any component contacted by the thermal interface material 50.

It should be noted that these design strategies require thermal modelling, know to those skilled in the art, to exactly parameterise the design of the optical sub-assembly based on the desired set of components to be packaged.

The separation of low and high power devices allows unusual functionality to be added to the OSA 28. At the lower end of the scale, the remaining components on the transceiver PCB can be integrated thus significantly reducing the overall size of a transceiver. At the upper end of the scale, an FPGA with an embedded transceiver can be added to provide further functionality such as protocol transparency and on chip reconfigurability.

This type of device is referred to as dynamic serial optical interconnect (DSOI).

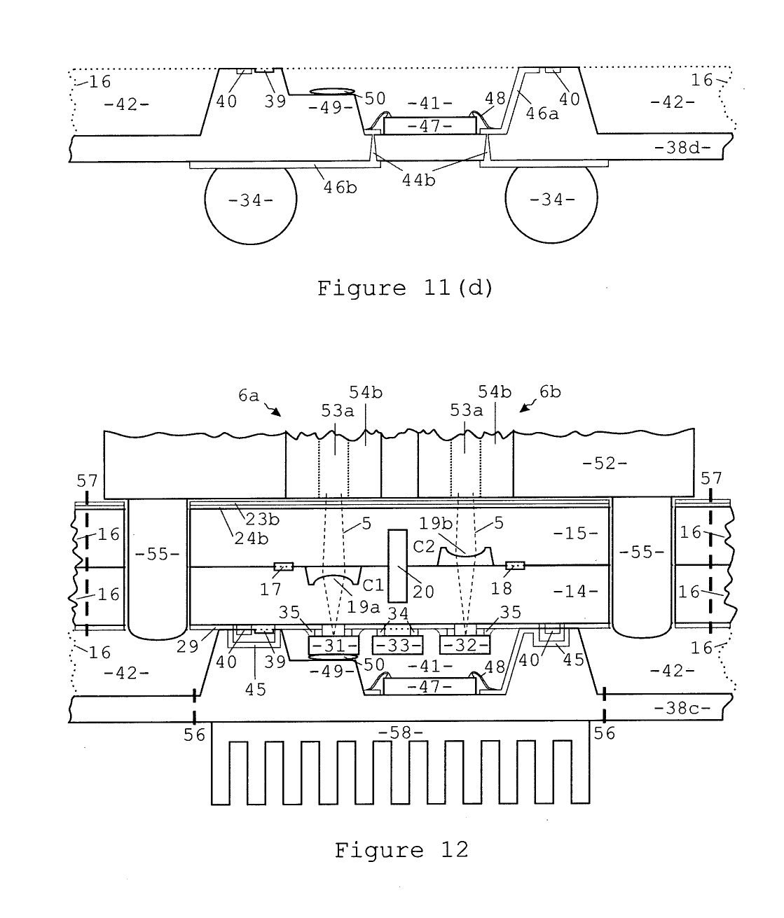

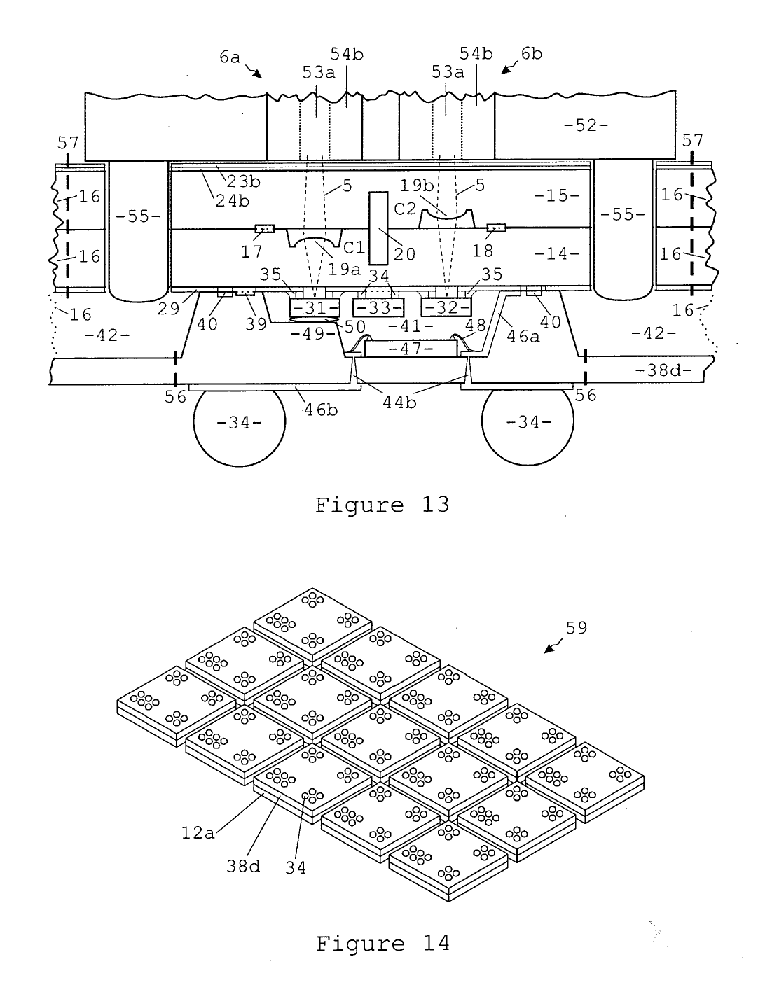

The final processing step before singulation is carried out is to bond the shell wafer, 38a, 38b, 38c, or 38d, to the optical wafer 12a using the sealing ring 40 and the above described methods. FIG. 12 provides a schematic example of a flex based OSA 28a, namely shell wafer 38c bonded to optical wafer 12a, while FIG. 13 provides a schematic example of a BGA OSA 28b, namely shell wafer 38d, bonded to optical wafer 12a.

FIGS. 12 and 13 further show an example connector 52 (of MT-RJ type), comprising two fibres 6a and 6b, interfaced with the optical sub-assemblies, 28a and 28b respectively, where channel C1 is arranged to be transmit and channel C2 to receive. Each of the fibres can be seen to comprise core, 53a and 53b, cladding, 54a and 54b, regions. The dashed lines 5 again indicate the optical paths and the alignment pins of the connector are denoted by reference numerals 55. Note that these diagrams show reasonable gaps between the pins 55 and the OSAs 28a and 28b. The size of these gaps is exaggerated to emphasise the fact that these are separate parts. Furthermore, the OSAs 28a and 28b would typically be embedded in a plastic strain relief which is not illustrated here.

To singulate out the devices, a staggered cut is necessary for the flex based OSA 28a of FIG. 12. First, a cut 56 is made around the device using a standard wafer scale saw process or similar. This cut need only expose the outer cavities 42 and does not go into the optical wafer 12a, but effectively cuts the shell wafer 38c into bonded islands on the optical wafer 12a. This cut 56 is positioned so that if alignment pins 55 exceed the outer cavities 42 they do not apply force to the anterior surface of the shell wafer 38c. The singulation of the optical carrier is completed using a standard wafer scale saw process or similar. A second cut 57 exposes sections of the electrical connection layer 29 enabling the bonding of a flex, or similar connecting element, using wire bonding, hot bar solder, adhesive or any other appropriate technique.

It should be noted that the BGA based OSA 28b does not need the cut 57 as the electrical tracks 46 come through to the posterior surface of the shell wafer 38c.

In the flex based OSA 28a, an optional heat sink 58 can easily be added, allowing higher power devices to be incorporated into the package.

FIG. 14 shows an example of a complete BGA based OSA wafer 59 that has just undergone singulation. In this example the optical wafer 12a is shown on the bottom and the shell wafer 38d is on the top. An array of solder bumps 34 can be seen on the top but this design is such that the alignment pin holes 30 do not protrude from the shell wafer 38d.

### Remarks

Detailed above are wafer scale optical sub-assembly (OSA) designs and methodologies comprising embedded optical coupling protected from the environment. The OSAs are fitted with optical transmit and/or receive elements for light transmission through an optically transparent carrier and include an integrated crosstalk reduction feature. All of the component elements are passively aligned to a master reference structure.

In addition, there are some further optional, advantageous design features. These include a hermetic shell wafer and the ability to add functionality, including protocol independence and a method of tuning thermal dissipation to ensure that unique temperature requirements can be met for each device.

It is important to note that the order of the above described processing stages is highly flexible. The particular order of the stages ultimately depends on the materials and design options selected for the OSA.

The described OSAs are intended to provide a credible alternative to the TO-can package transceiver combinations known in the art. The described OSAs address many of the outstanding issues in transceiver design by offering a high density MT connector compatible design suitable for high volume wafer scale manufacture.

In particular, the optical sub-assembly designs outlined above provide a number of improvements over existing assemblies in that they add a set of features that are considered unique, namely:
One key advantage of the described OSAs is that the majority of optical feature processing can be done with the same laser source by simply varying power levels. This includes everything from the lenses to the alignment pin holes. The laser processed optical features can offer waveguiding, powerful focussing, optical isolation and optical crosstalk reduction blocks;
The design of the optical features allows both transmit and receive functionality and arrays of optical devices to be packaged together. Although arrays of devices are known in the art, their designs do not take account of optical crosstalk reduction, optical isolation or connectorisation. It is well known in the art that optical crosstalk is a significant problem in the design of optical sub-assemblies;
Three distinct methods to create optical crosstalk reduction trenches are discussed. These include trenches that are reflecting, opaque or diffusing in nature. Each design fits neatly in with the same processing methodology as the rest of the OSA;
The described optical wafers are resilient to dust, dirt, contaminants and further processing because of the embedded nature of the optical features. Due to the resilience of the designs, any contamination or damage not prevented by the sacrificial layers can be removed with a simple polish or etch. Existing designs are such that lens elements are exposed and therefore susceptible to damage, in particular from post-processing steps;
Furthermore, the described optical wafers provide an ideal flat surface for coupling to any optical signals;
A significant physical size reduction over existing solutions that connect to parallel MT style connectors together is achieved due to the design of the optical features. With the TO-can packaged systems, physical size prohibits any connectorisation without a complex fibre based fan-in and fan-out structure that is not only large, but also complex and expensive to build. With MEMs, the size and placement requirements of hemispherical lenses result in complex and costly solutions that are highly problematic to fit into small volumes;
The OSA can be assembled directly on the optical wafers. This is only feasible because of the resilience of the optical system design. Conventional designs either apply components post assembly or employ additional carriers with optical components;
Features or devices can be structured or fabricated on the optical wafers without the need for active alignment of lenses as a post process. These devices could include VCSELs, detectors or multi-layer electrical patterning. This is only possible due to the embedded nature of the optical elements. Typical fabrication or patterning methodologies do not take advantage of embedded elements, nor are they employed as a device reference point;
The use of passive alignment process, using a fixed reference point, means that alignment errors do not stack. This enables the tight tolerances required by optical fibre systems to be met when assembling directly on the optical wafer;
Integrated connector alignment holes means that no additional jigs or fixtures are required to align to an MT fibre connector making the OSAs a directly coupled device. Existing designs do not consider how the physical connector is toleranced or mated correctly with the packaged components, and typically assume an active alignment step;
High and low power dies can be packaged in the same device. A thermal tuning technique is outlined that allows temperature sensitive die to be interfaced to the same heat sink as temperature insensitive die. This enables devices previously resident on the transceiver PCB to be incorporated into the OSA. Existing designs do not use this method due to the known thermal problems involved;
The OSA can be hermetically sealed. The design allows the use of a micromachined cap that also serves as a heat sink for higher thermal output die that have been assembled on the optical wafer. In addition, larger die can be added into the cap which provides additional real estate. Conventional techniques add this functionality to the transceiver PCB;
The presently described systems are designed specifically for wafer scale packaging. Existing designs are not built completely, including connector alignment, on a single wafer.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. An optical wafer comprising:
a transparent substrate;
a fiducial;
one or more optical channels embedded within the transparent substrate with reference to the fiducial; and
a mechanical alignment feature located with reference to the fiducial.

2. An optical wafer as claimed in claim 1, wherein a cross-talk reduction feature is embedded within the transparent substrate with reference to the fiducial and located between a first and a second optical channel.

3. An optical wafer as claimed in claim 1, wherein additional features of the optical wafer are also aligned with respect to the same single reference fiducial.

4. An optical wafer as claimed in claim 1, wherein the optical wafer comprises a plurality of reference fiducials.

5. An optical wafer as claimed in claim 1, wherein the fiducial is embedded within the transparent substrate.

6. (canceled)

7. An optical wafer as claimed in claim 1 wherein the transparent substrate comprises a transparent layer and a transparent cap.

8. An optical wafer as claimed in claim 7, wherein at least one of the one or more optical channels comprises a refractive optical feature located within the transparent layer.

9. An optical wafer as claimed in claim 7, wherein at least one of the one or more optical channels comprises a refractive optical feature located within the transparent cap.

10. An optical wafer as claimed in claim 7 comprising a first fiducial located within the transparent layer and a second fiducial located within the transparent cap.

11. An optical wafer as claimed in claim 2, wherein the transparent substrate comprises a transparent layer and a transparent cap, and wherein the crosstalk reduction feature comprises a first part located within the transparent layer and/or a second part located within the transparent cap.

12. An optical wafer as claimed in claim 2, wherein the crosstalk reduction feature comprises an optically opaque material, an optically diffuse material or an optically reflective material.

13. (canceled)

14. (canceled)

15. An optical wafer as claimed in claim 1, wherein the mechanical alignment feature comprises a negative mechanical structure which extends into or through the transparent substrate.

16. An optical wafer as claimed in claim 1, wherein the mechanical alignment feature comprises a positive mechanical structure which extends out of the transparent substrate.

17. An optical wafer as claimed in claim 1, wherein the optical wafer comprises a plurality of mechanical alignment features.

18. An optical sub-assembly (OSA), the optical sub-assembly comprising an optical carrier wherein the optical carrier comprises an optical wafer as claimed in claim 1.

19. An optical sub-assembly (OSA) as claimed in claim 18, wherein the OSA further comprises an electrical connection layer processed on a first surface of the transparent substrate with reference to the fiducial.

20. An optical sub-assembly (OSA) as claimed in claim 18, wherein the OSA further comprises an anti-reflection coating processed on a second surface of the transparent substrate.

21. An optical sub-assembly (OSA) as claimed in claim 19, wherein the OSA further comprises an optoelectronic device electrically connected to the electrical connection layer with reference to the fiducial.

22. An optical sub-assembly (OSA) as claimed in claim 21, wherein the OSA further comprises a glob top arranged to provide physical protection to at least part of the optoelectronic device.

23. An optical sub-assembly (OSA) as claimed in claim 21, wherein the OSA further comprises a shell wafer arranged to provide physical protection to at least part of the optoelectronic device located with reference to the fiducial.

24. An optical sub-assembly (OSA) as claimed in claim 23, wherein the shell wafer comprises a sealing ring, positioned with reference to the fiducial, such that the shell wafer hermetically seals the optoelectronic device within a central cavity.

25. An optical sub-assembly (OSA) as claimed in claim 23, wherein one or more components of the optoelectronic device are mounted on an anterior surface of the shell wafer such that they do not make direct contact with the optical wafer.

26. An optical sub-assembly (OSA) as claimed in claim 23, wherein the shell wafer comprises one or more shelves wherein the anterior surface of the shell wafer corresponding to the one or more shelves lies closer to the optical wafer than the anterior surface of the remainder of the shell wafer.

27. An optical sub-assembly (OSA) as claimed in claim 26, wherein a thermal interface material is located on the one or more shelves.

28. An optical sub-assembly (OSA) as claimed in claim 23, wherein the shell wafer comprises offset cuts to allow bonding to the electrical connection layer.

29. An optical sub-assembly (OSA) as claimed in claim 28, wherein the offset cut shell wafer comprises a heat sink thermally connected to a posterior surface of the offset cut shell wafer.

30. An optical sub-assembly (OSA) as claimed in claim 23, wherein the shell wafer comprises a ball grid array (BGA) based shell wafer.

31. An optical sub-assembly wafer wherein the optical sub-assembly wafer comprises one or more optical sub- assemblies as claimed in claim 18.

32. A method of production of an optical wafer, the method comprising:
1) processing a transparent substrate so as to provide the transparent substrate with a fiducial;
2) embedding and aligning at least one optical feature within the transparent substrate with respect to the fiducial; and
3) locating a mechanical alignment feature with reference to the fiducial.

33. A method of production of an optical wafer as claimed in claim 32, the method further comprising the step of processing the transparent substrate so as to provide a crosstalk reduction feature between two or more embedded optical features.

34. A method of production of an optical wafer as claimed in claim 32, wherein the step of embedding and aligning at least one optical feature within the transparent substrate comprises:
1) processing a transparent layer so as to provide the transparent layer with at least one fiducial and at least optical feature; and
2) bonding a transparent cap to the transparent layer.

35. A method of production of an optical wafer as claimed in claim 34, the method further comprising the step of processing the transparent cap so as to provide the transparent cap with at least one fiducial.

36. A method of production of an optical wafer as claimed in claim 35, wherein the step of bonding the transparent cap to the transparent layer comprises aligning the at least one reference fiducials of the cap and the layer.

37. A method of production of an optical wafer as claimed in claim 34, wherein the method further comprises the step of processing the transparent cap so as to provide a crosstalk reduction feature suitable for locating with the at least one optical feature of the transparent layer.

38. A method of production of an optical wafer as claimed in claim 34, wherein the method further comprises the step of processing the transparent cap so as to provide at least one isolation planes suitable for ensuring that light is not reflected back along the optical channel.

39. A method of production of an optical wafer as claimed in claim 34, wherein the method further comprises the step of processing the transparent cap so as to provide at least one lens such that when bonded to the transparent layer the optical wafer comprises two or more embedded optical channels.

40. A method of production of an optical wafer as claimed in claim 34 the step comprises the processing of a first crosstalk reduction feature within the transparent layer and a second crosstalk reduction feature within the transparent cap the first and second crosstalk reduction features being aligned when the transparent cap is bonded to the transparent layer .

41. A method of production of an optical wafer as claimed in claim 40, the method further comprising filling the first and/or second crosstalk reduction features with an optically opaque material prior to bonding.

42. A method of production of an optical wafer as claimed in claim 32, wherein the step of embedding at least one optical feature within the transparent substrate comprises the step of processing the transparent substrate so as to form at least one sub-surface optical channel.

43. A method of production of an optical wafer as claimed in claim 32, wherein the step of providing the fiducial comprises the steps of:
1) applying a high powered laser to process a first region of the transparent substrate; and
2) etching the transparent substrate so as to remove the processed first region of the transparent substrate.

44. A method of production of an optical wafer as claimed in claim 42, wherein the processing of the transparent substrate so as to form at least one sub-surface optical channel comprises the step of focussing a low powered laser within at least one subsurface region of the transparent substrate so as induce a thermal refractive index change within the subsurface region.

45. A method of production of an optical wafer as claimed in claim 44, wherein the induced thermal refractive index change is controlled so as to process a lens within the subsurface region.

46. A method of production of an optical wafer as claimed in claim 44, wherein the induced thermal refractive index change is controlled so as to process a waveguide within the subsurface region.

47. A method of production of an optical wafer as claimed in claim 32, wherein the step of embedding at least one optical feature comprises processing the transparent substrate so as to provide the transparent substrate with one or more embedded optical channels.

48. A method of production of an optical wafer as claimed in claim 47, wherein the method further comprises the step of processing a subsurface region of the transparent substrate so as provide a crosstalk reduction feature between two or more embedded optical channels.

49. A method of production of an optical wafer as claimed in claim 48, wherein the step of processing the subsurface region of the transparent substrate so as provide a crosstalk reduction feature comprises the step of focussing a high powered laser within the subsurface region.

50. A method of production of an optical wafer as claimed in claim 48, wherein the step of processing the subsurface region of the transparent substrate so as provide a crosstalk reduction feature comprises the step of focussing a low powered laser within the subsurface region.

51. A method of producing an optical sub-assembly the method comprising the steps of:
1) applying an electrical connection layer to an optical wafer as claimed in claim 1;
2) attaching an optoelectronic device to the electrical connection layer.

52. A method of producing an optical sub-assembly as claimed in claim 51, wherein the method further comprises the step of bonding a glob top to the optical wafer so as to provide physical protection to at least part of the optoelectronic device.

53. A method of producing an optical sub-assembly as claimed in claim 51, wherein the method further comprises the step of bonding a shell wafer to the optical wafer so as to provide physical protection and/or additional thermal management to at least part of the optoelectronic device.

54. A method of producing an optical sub-assembly as claimed in claim 51, wherein the method further comprises the step of bonding a shell wafer to the optical wafer and populating the anterior of the shell so as to provide physical protection and/or thermal management to at least part of the optoelectronic device while allowing high power components to be combined with thermally sensitive ones .

55. A method of producing an optical sub-assembly as claimed in claim 53 wherein the method further comprises the step of offset cutting the optical wafer with reference to the shell to allow bonding to the electrical connection layer.

56. A method of producing an optical sub-assembly as claimed in claim 51, wherein the method further comprises the step of cutting the optical wafer so as to singulate the optical sub-assembly.

57. An optical wafer as claimed in claim 1, wherein at least one of the one or more optical channels comprises a waveguide located within the transparent layer.

58. The optical sub-assembly (OSA) as claimed in claim 18, wherein at least one of the one or more optical channels of the optical wafer comprises a waveguide located within the transparent layer.

59. The optical sub-assembly (OSA) as claimed in claim 18, wherein the transparent substrate of the optical wafer comprises a transparent layer and a transparent cap.

60. An optical sub-assembly (OSA) as claimed in claim 24, wherein the central cavity comprises one or more shelves and wherein the anterior surface of the shell wafer corresponding to the one or more shelves lies closer to the optical wafer than the anterior surface of the remainder of the central cavity.
